(19) United States
(12) Patent Application Publication
(10) Pub. No.: US 2024/0029164 A1
(43) Pub. Date: Jan. 25, 2024

(54) Defined Contribution Plan Performance Tracking Tool

(71) Applicant: Kulangara Sivadas, Foothill Ranch, CA (US)

(72) Inventor: Kulangara Sivadas, Foothill Ranch, CA (US)

(21) Appl. No.: 18/355,349

(22) Filed: Jul. 19, 2023

Related U.S. Application Data
(60) Provisional application No. 63/390,635, filed on Jul. 20, 2022.

(51) Int. Cl. G06Q 40/06

(52) U.S. Cl. CPC G06Q 40/06

(57) ABSTRACT

This invention concerns systems and methods for individuals to collaboratively share performance data of Defined Contribution Plans (DCPs) they participate in. By applying individually subjective scaling factors, asset positions in participants' accounts are pared down to meaningful performance indices, while masking actual wealth information. In other words, the present invention enables and enforces revelation of participant-identities in a safe manner, improving transparency and trust among the participants. As a result, in a close-knit community such as a workplace environment where employees know each other and abide by a common set of values and behaviors, this invention coerces truthfulness in data-sharing among peers. This tool alleviates retirement anxiety among wage earners and help them make realistic retirement savings goals, by constantly validating the market through self & peer experiences and not solely relying on provider statements.

### CROSS REFERENCE TO RELATED APPLICATIONS

This application claims the benefit of PPA Ser. No. 63/390,635 filed Jul. 20, 2022 by the present inventor, which is incorporated by reference.

### BACKGROUND OF THE INVENTION

The retirement nest egg for majority of wage-earners in the US (and perhaps outside) is their employer sponsored Retirement Savings Account funded by a Defined Contribution Plan (DCP) such as a 401k account, a 403(b) annuity account or a 7702 policy (insurance with cash value). It's perhaps the most valuable asset of their lifetime (other than the home they live in) for lower-middle income workers. And yet, a significant fraction (a 39% as of 2022) of the 401k plan participants blindly let their contributions go to Target Date Funds (TDFs) which have been shown to be underperforming some of the common (and less expensive) S&P 500-tracking funds even on 10 or 15 years of timescale [as found out by Paul Price of Real Money]. This sad situation exists in spite of the fact that most employers in their 401k plans offer a variety of stock, bond and money market indexed funds, a 40% of them offering even Self Directed Brokerage Accounts (SDBAs) and Brokerage Windows. It was also found that only 3-4% of plan participants utilize their SDBA options [per Aon Hewitt]. At least one specification heading is required.

One of the prime reasons for DCP participants (employees) preferring TDFs, aside from their ease of management, is that they aren't much aware of anything else. DCP providers (also known as plan administrators) or sponsors (employers who hire the plan providers to run their DCPs) aren't so motivated in educating the participants on the rewards waiting for moderate risk takers in the market. For those who study this problem closely it can be seen that, there isn't a user-friendly tool out there that compares performances of various DCP options available to an employee and matches them with his/her individual risk tolerance level. Generic dashboards provided by plan administrators are inadequate for this purpose. Most often, they avoid using graphics in communicating trends and their unintuitive spreadsheets are riddled with financial jargons unfamiliar to the participants. An instance is when an employee would want to simply see a time-chart of whether his/her TDF contributions have been going into a sinkhole from paycheck to paycheck. And what if the employee wanted to know whether investment in an annuity policy or a bank CD or even another DCP component (fund option sponsored by the employer) would have been a better choice?

For example, dashboards provided by DCP administrators do not always let the participants choose appropriate timescales to present wholistic data in volatile markets. Generally, they would make it hard to obtain/contrast historic Net Asset Values (NAVs) of their DCP offerings all at one place. Also, they're careful not to separate periodic contribution amounts from the net holding values on any infographic. They avoid presenting full-history charts on performance data (such as drawdown figure comparisons) to their customers. And most importantly, they do not factor inflation (variations in Consumer Price Index or CPI) when reporting their fund performance.

Due to a lack of historic performance data on various DCP options (such as easily accessible daily NAVs) it has been hard to simulate what-if scenarios on past performances which would've given valuable market insights to inexperienced participants. For example, using the currently available tools, it's hard to simulate what would've happened if a participant stayed away from the market (such as by parking all assets in a cash fund) in the first two quarters of 2022 or delayed his/her retirement by 2 years. Similarly, it isn't possible for a TDF 2045 participant to compare his/her savings performance against a TDF 2030 or Large Cap Index Fund participant because there's no way to obtain another participant's fund performance information.

Also in the current workplace savings investment scenario, it's hard for a rooky participant to estimate and declare an ‘acceptable risk tolerance level’ (which is the basis of investment fund selection performed by any DCP provider) all by himself/herself. However, watching and learning from a group of trusted workplace peers and retirees having experience with the same exact portfolios (DCP offerings), and in previous bullish/bearish markets makes it easier for him/her to depart from the one-size-fits-all-TDF funds.

Due to the above reasons, it has been necessary to have a platform where retirement fund performances, goals and stories could be narrated by the participants themselves, in their own layman's language (avoiding financial jargons used by the providers) and using plenty of simple graphics.

### SUMMARY OF THE INVENTION

Accordingly, one aspect of the invention is to address one or more of the drawbacks set forth above.

According to the embodiments disclosed, the present invention is an investment advisory tool comprising at least one Data Sharing Platform (DSP) having server computers, custom host software, custom client software, client computers (such as, but not limited to, smartphones and smart wearables) and interconnecting data networks. The tool is preferably hosted by a cloud service.

The investment advisory tool in its minimalistic configuration, is purposed to help its users who are typically employees working under a common employer and participating in DCPs sponsored by their employer. The tool works in agreement and conjunction with the employees, preferably in partnership with the employer and the DCP administrator and provides a secure internet domain for its users to collaborate.

The tool collects historic and current DCP contributions, market values of investments and calculates wealth positions in the RSAs of its users on a real-time or need basis (such as, but not limited to, a daily basis or a pay-day basis) in an autonomous or manually driven mode. The tool can be configured to accept information directly from DCP participants (such as, but not limited to, the paychecks of employees that participate) or DCP sponsors (such as, but not limited to, the databases of employers where the participants work) or internet domains (such as, but not limited to, webpages that publish trading information) or DCP provider/administrators or even a combination of the above.

Performance gains/losses in each DCP component (i.e., discrete fund option made available to the participant to invest) is then ‘normalized’ with respect to the individual's contribution into that component and is shared among peers (at the discretion of the individual) without divulging the holding amounts.

At a minimum, it's envisaged to be a tool to mitigate “retirement anxiety” of wage earners working under a common employer (and thereby) having similar investment prospects, saving potential etc.

On the other hand, it is a tool that helps lay employees learn from other's experiences, such as by knowing, who among the colleagues are getting better growth or less volatility by virtue of their DCP component choices. The tool allows employees to dabble a bit in assessing market risks, steer away confidently from low-yield TDFs, set realistic retirement goals, boost own investment performance, advocate for better DCP choices/administrators and even positively influence the savings habit of younger hires—all made possible by the availability of collaboratively sourced live data from peers and retirees.

### BRIEF DESCRIPTION OF FIGURES

The purpose and advantages of the present invention will be apparent to those of skill in the art from the following detailed description in conjunction with the appended drawings in which like reference characters are used to indicate like elements, and in which:

FIG. 1 depicts a data sharing community using the present tool-invention to compare performances of DCP components offered to them.

FIG. 2 shows two data sharing communities, interlinked to compare their DCP offerings.

FIG. 3 shows employees of four different companies comparing their DCP components' performances administered by two separate providers.

FIG. 4 is a typical Defined Contribution Plan menu (DCP) offered by an employer.

FIG. 5 shows a computational flow diagram that calculates HV, CCG and AG time series.

FIG. 6 depicts how Consumer Price Index (CPI) could vary from time to time.

FIG. 7 shows sample calculations for HV, CCG and AG values in a tabular format.

FIG. 8 illustrates a Graphical User Interface (GUI) or Data Dashboard of the tool-invention that participants interact with.

### DETAILED DESCRIPTION OF THE INVENTION

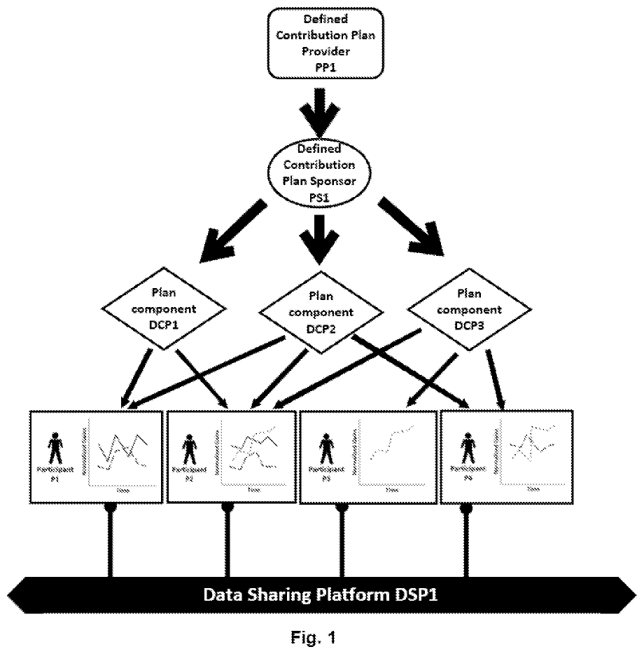

FIG. 1 is illustration of a community utilizing the present invention (also known as ‘the tool’ hereafter) to share their retirement savings positions among peers at workplace. The community members P1, P2, P3 and P4 are employees working under a common employer PS1 (usually a company or organization who's also the sponsor of the DCP), contribute to various DCP components available to them (DCP1, DCP2 and DCP3 shown) while sharing their RSA performance indices on a platform shown as DSP1 (typically the server-hosted parts of the tool). Per FIG. 1, while member P1 chose DCP1 & DCP2, P2 subscribed to all the three components offered, P3 chose only DCP3 and P4 went with DCP2 & DCP3. The DCP plan is provided and administered by PP1 (could be any financial company such as Charles Schwab, Fidelity etc.). In a preferred scenario, the client-interacting part of the tool is an ‘app’ that is available for downloading and installation from the internet on employee-owned smartphones, computers etc. Employees typically subscribe to the tool by registering at the tool's portal using their workplace credentials. Employees are allowed to roll over funds from their previous plans and have access to the tool even after retirement and as long as they keep their savings in the DCP.

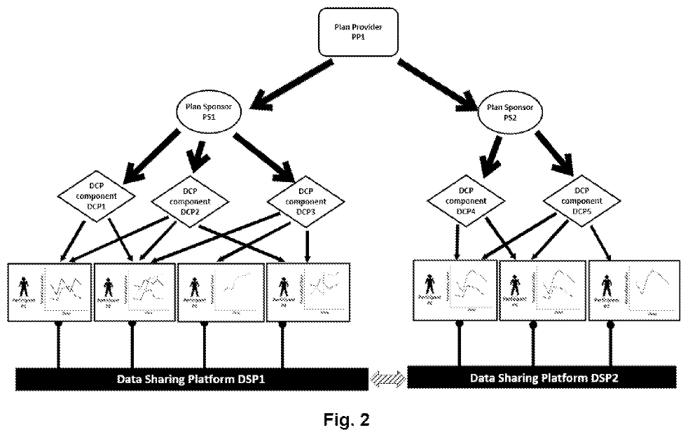

Plan providers such as Fidelity offer hundreds of varieties of DCPs to their thousands of clients (employers in various employment sectors) depending on client choices. It's natural that employees of a certain company (say Apple) would want to know the kind of DCP components offered to the employees at a rival company (say Google), often by the same plan provider (say Vanguard). FIG. 2 depicts the scenario where two communities, the first one being employees of PS1 company and the second one being employees of PS2 company, linking their respective data sharing platforms DSP1 and DSP2, in order to compare performances of their plan offerings, in this case administered by the same plan provider which is financial company PP1.

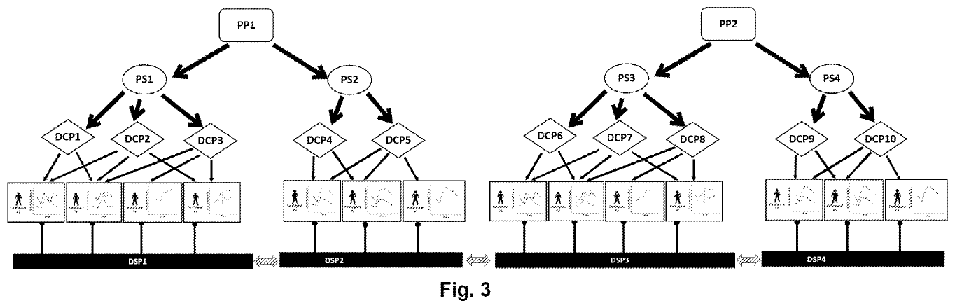

FIG. 3 shows DCP components offered by a plurality of providers PP1 and PP2 for four disparate employers PS1, PS2, PS3 and PS4, being compared by their employees by using the tool-invention that links respective data sharing platforms DSP1, DSP2, DSP3 and DSP4. Such wide collaboration possibilities between employee communities using the tool makes it easier to contrast between even different genres of retirement products such as 7702 plans vs 401k plans.

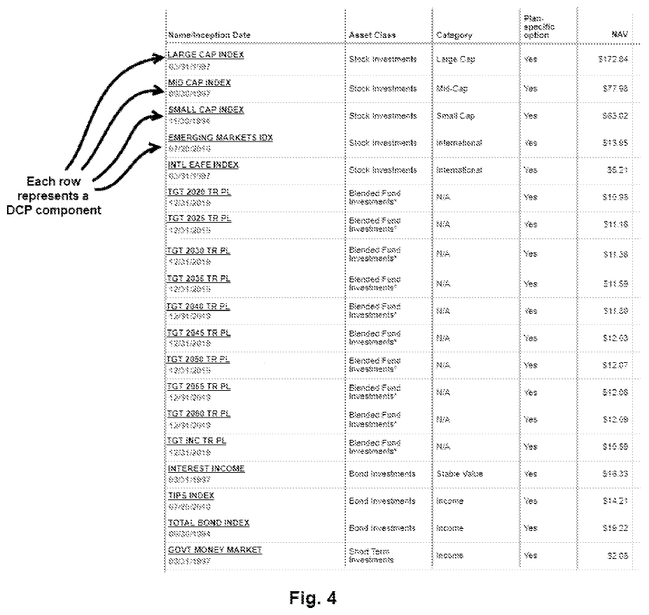

FIG. 4 illustrates a typical Defined Contribution Plan-menu sponsored by an employer. Each row of the menu is a component of the Defined Contribution Plan (to be known as a ‘DCP component’ hereinafter) that employees can choose from. While some employers offer only a handful of Target Date Funds (TDFs) that have a mix of tradeable asset classes in a ratio defined by ‘years-to-retire glide paths’ (such funds exemplified by rows 6, 7, 8, 9 etc. in FIG. 4), others offer a variety of stock & bond index funds, money market funds, Self-Directed Brokerage Accounts, brokerage windows etc.

In its most preferred embodiment, the tool has a software application (the App) component running on an application computer such as a participant-employee's smart phone or desktop. It would preferably have an integrated user authentication service set up between the application's server and servers of the employer and/or the financial company who administers employee's DCP. Such an arrangement, if desired, permits the App to access the employee's account transactions on behalf of the employee at regular intervals and perform analytics. The App could also work in a manually driven mode where launching, data entry, authorized data fetching, running analytics, display of results, storage of results etc. could be initiated by the user (the employee-participant) in sessions authenticated via means such as, but not limited to SSO.

A computer system (including but not limited to the application computer and its servers) is configured to obtain DCP transaction data (including but not limited to periodic contributions, employer matches, dividends, roll-overs, fees, market gain/losses) from the DCP provider's servers or employers' payroll servers via means such as, but not limited to API endpoints, at periodic intervals (including, but not limited to pay-check days) automatically or at the instance of the user or from manual data entry by the user. Any such automatic fetching of fund transaction data is preferably implemented using secured token exchanges between said servers.

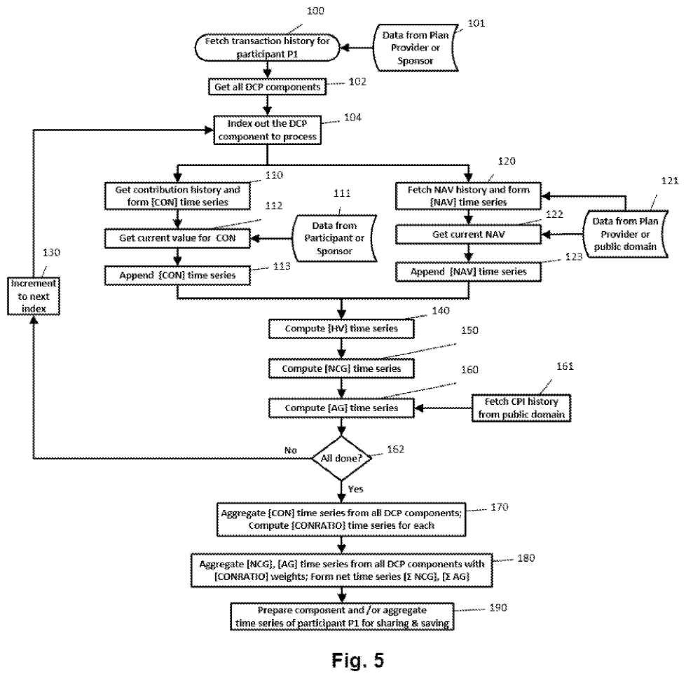

FIG. 5 is a schematic of computational steps involved in the tool's working for a hypothetical DCP participant P1 who has been with his employer (who sponsors the DCP in the form of a 401k plan administered by Fidelity) for several years. Suppose that he diligently started saving for retirement by participating in the DCP from the start of his employment, directing 75% of his 401k contributions to a Target Date Fund (say TDF2040) and the remaining 25% to a stock index fund (say Emerging Markets Index or EMI fund) on each payday. His employer matched dollar to dollar on all 401k contributions and the matching contribution was also allowed to be invested in the same manner. Let's assume that the employee started subscribing to the tool service only 2 years after beginning his DCP participation.

In the above scenario, as soon as P1 installs the App on his smartphone and registers his tool-subscription membership using his workplace credentials, his employer's and Fidelity's servers recognize him and allows the App to securely access his information related to payroll, 401k account etc. As depicted in FIG. 5, all DCP-related data from plan provider and/or sponsor, including P1's two-year worth of transaction histories are fetched 100 into the App server computers for processing. The first step 102 involves getting the DCP components which are TDF2040 and EMI funds in this case. Then the iterative loop shown in FIG. 5 begins executing the first cycle by indexing out 104 the first component DCP1 to process (say the TDF2040 Fund).

The tool processes one DCP component per iteration (cycle) of the loop. Since there are two DCP components in P1's case, the iterative loop runs only two times. In every cycle the tool finds 110 the historical values of CON (the paycheck-wise contribution amount) made towards the current DCP component being processed along with contribution timestamps from the transaction histories previously loaded from the authenticated servers (as described in the previous paragraph). The tool is also capable of appending 112 the history-file instantaneously when a new contribution occurs 111. The tool then creates 113 a time-series of CON values organized according to the order of associated timestamps.

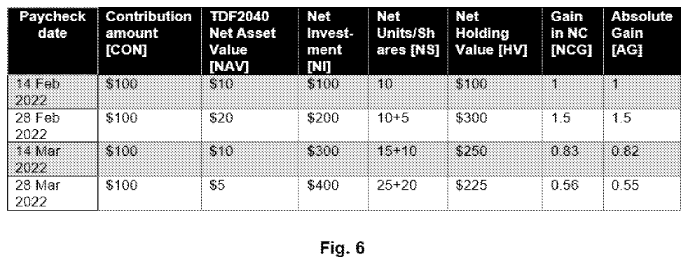

Further the tool proceeds to compute three performance indices for DCP1 investment component, labeled Net Holding Value HV, Gain in nominal currency NCG and absolute gain AG (steps 140, 150 and 160 in FIG. 5), at each instance of contribution payment, and forms time series of HV values, CCG values and AG values. In order to compute these indices, it's necessary to know the Net Asset Value NAV of DCP1 at each instance (timestamp) of contribution payment CON. The tool gets 120 historic NAV values as well as 122 the instant values to create 123 a time series of NAV values. These values are either supplied by the DCP provider or fetched 121 from public domains, stock exchange publications etc. whenever it's needed. The paragraphs below together with FIG. 6 explain how the performance indices are computed.

FIG. 6 is a table illustrating some sample calculations. For the sake of simplicity, let's consider just 4 pay-periods during which the employee contributes $100 on each paycheck-date, towards DCP1. Contribution dates and amounts are shown in column #1 and #2 in the table. Column #3 has the Net Asset Values of DCP1 (unit price of TDF2040 published by the fund provider) on the respective contribution dates. Following are the steps involved in calculating the three time series comprising of HV, NCG and AG values. For convenience let's annotate the three time series as [HV], [NCG] and [AG] respectively.

Net Investment value on [NI] time series, on any given date, is sum of the previous contributions. i.e.,

$${[ NI ]}_{current} = {\sum }_{past} [ CON ]$$

Net number of shares/units of DCP₁ owned by the employee on any given date NS is the sum of share counts he purchased on each contribution date, at the prevailing value of NAV. i.e., on each contribution date. So the time series for NS is formed by

$${[ NS ]}_{current} = \frac{{[ CON ]}_{current}}{{[ NAV ]}_{current}} + {\sum }_{past} [ NS ]$$

Accordingly, Holding Value at any time on the [HV] time series is the total Net Asset Value of currently held shares. Therefore, [HV] time series is calculated 140 as

[HV]_{current}=[NS]_{current}*[NAV]_{current}

Dividing 150 the value HV at any time by the total cost basis NI of that time, gives Nominal Currency Gain NCG at that time. Hence the [NCG] time series can be represented as,

$${[ NCG ]}_{current} = \frac{{[ HV ]}_{current}}{{[ NI ]}_{current}}$$

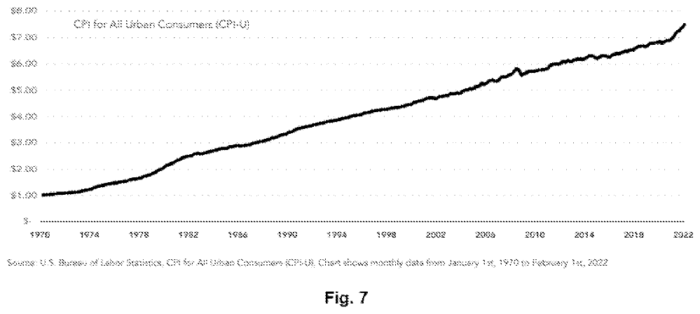

Finally, multiplying 160 values of NCG at a given time with prevailing Consumer Price Index CPI gives the Actual Gain [AG] time series:

[AG]_{current}=[NCG]_{current}*[CPI]_{current}

where [CPI] is a time series formed of the Consumer Price Index CPI values obtained 161 from the government authorities. In general terms, CPI represents the value erosion happening to the local currency in the respective market due to inflation. For illustrative purposes, the chart in FIG. 7 shows the overall inflation happened to the value of $1 between 1970 and 2022 (monthly data from Jan. 1, 1970 to Feb. 1, 2022, available from U.S. Bureau of Labor Statistics). It means that 2022's dollar would be worth only 13 cents back in 1970. Value of CPI in that sense will always be a proper fraction (of value between 0 and 1) and therefore AGs will be smaller than NCGs per the last equation above.

After saving the time series of performance indices for DCP1, the second cycle of the iterative loop executes where the above process repeats for the DCP2 component (the EMI fund in this case). Time series of performance indices for DCP2 is also saved. Execution cycles reiterate 162 until all DCP components are processed and exits the loop. In step 170 the tool computes a ratio CONRATIO, at each of the pay-check instances, between each CON value of each DCP component and sum of all CON values for that instance. For example, let's say P1 contributed $100 towards TDF2040 Fund and $200 towards EMI Fund on 14 Feb. 2022. Then CONRATIO calculation for DCP1 component for that date is 100÷└100+200┘, which is 0.33 and that for DCP2 is 200/└100+200┘, which is 0.66. The tool goes on to compute CONRATIO values at every timestamp of each DCP component and creates individual time series of CONRATIO values (annotated as [CONRATIO]) for each DCP component. In the next step 180, a weighted array addition of every [NCG] time series is done, which is essentially summation of [NCG] elements after multiplying each element with the corresponding [CONRATIO] element for that timestamp. In the example above, since the NCG value for DCP1 is 1.0 on Feb. 1, 2022, as depicted in 1st row, 7th column of FIG. 6, and assuming an NGC value of 2.0 for DCP2 on the same date, (and the CONRATIO values being 0.33 and 0.66 as calculated previously for the same date), NCG weighted summation will be [1.0×0.33]+[2.0×0.66], which is 1.65. The process when repeated on each timestamp across all the stored [NCG] time series results 180 in the aggregate time series, annotated as [ΣNCG]. In a similar way [CON RATIO] elements when used to ‘weigh and add’ all [AG] time series, gives an aggregate time series [FAG], which indicates the overall performance of investments made in DCP by the employee/participant.

In step 190, the tool could select whether component or aggregated performance indices could be shared depending on the user's settings. Participants are able to view and analyze aggregated or component performances belonging to any individual or subset of the community depending on their view-settings on the dashboard.

Regarding [CON] time series such as the one shown in the 2nd column of the table of FIG. 6, it may be noted that its member values could be zero or even negative depending on the nature of transaction. For example, [CON] elements would be zero when the participant stops contributing into the corresponding DCP component. If he/she moves money from a DCP component or makes a distribution (from the current HV value), that corresponding entry for CON would assume a negative number and rest of the row on FIG. 6 (i.e., NI, NS, HV, NCG and AG) would be updated taking the negative CON into account. In a similar way, if a participant rolls over his/her retirement savings from another employer, corresponding CON element could be an odd entry occurring on an aperiodic date, with respect to rest of the [CON] series elements. CON values could also represent contributions from any source other than the employee's regular paycheck contribution, such as a matching 401k contribution from the employer, employee's own supplementary contributions or a one off contribution made on a random date.

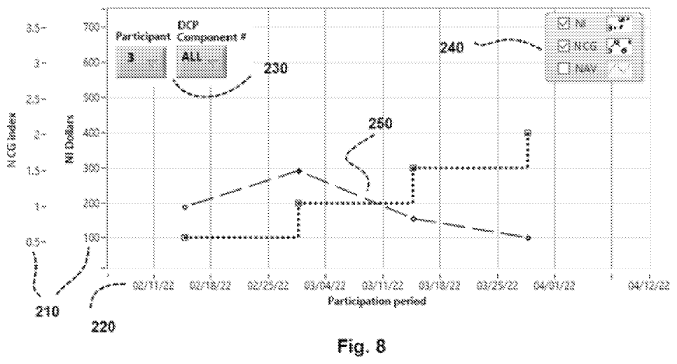

FIG. 8 is an embodiment of the GUI of the app that runs on client devices. This embodiment has been configured for displays that have preferably large rendering areas or high resolution with zooming capability where time charts in various styles, colors and their annotations are easily discerned by the user. Alternative GUI methods suiting smaller screens (such as on smartphones, smartwatches) are also envisaged where only abstracted data (such as sudden or significant deviations in NAVs, AGs, CONRATIOs etc. in any participants' data) would trigger eye-catching alerts on all participant phones. The tool allows setting software triggers when performance indices or DCPp of any participant or NAV of any DCP component deviates significantly from the norm.

GUI of FIG. 8 is interactive where a participant would choose to visualize his/her own data, other participants' data, community (group) data, statistically contrasted (post-processed) data on any chosen time scale along the X-axis 220. Depending on the choices made on palette 240, scales and parameters on Y-axis 210 are configured. Menus such as dropdowns 230 allow the user to find/filter other participants and their DCP data. The dynamic display area renders data in graphical 250, text, tabular etc. formats per settings made by the user.

The tool facilitates computation of performance indices NCG, AG etc. of funds on shifted time scales too. For example, if employee P1 wanted to compare his composite AG values (weighed aggregation of all DCP components) between another employee P2 who started participation a year later than P1, various time series of P1 and P2 could be calculated based off P2's starting timestamp.

While the above example describes the working of the tool on employer-sponsored 401k plans, it can handle other pension plans such as 403b in the same manner, where defined contribution happens every paycheck interval. The tool described above is designed to handle defined contribution plans other than employer-sponsored funds or 401k plans. An example is when an employee participant or even a retired/non-employed participant wants to put his/her money in a CD or in a 7702 insurance plan whose cash component growth can be tracked online and past performance data are available from providers.

Importantly, calculation of NS, HV, NCG and AG parameters depicted in FIG. 6 and plotted in FIG. 8, assumes that the entirety of HV sums were available to the participant to keep (as shares/units) but in actuality, the Plan Provider gets to pocket a fraction of the managed assets as their administrative/record-keeping fees once every quarter. Therefore, asset positions reported by the Plan Provider would be smaller than NS, HV etc. displayed by the tool. Such differences in reported positions (between the tool and the Provider) serve to remind the participant about the significant sums of fees being paid to the plan administrators.

I claim:

1. A Defined Contribution Plan (DCP) performance tracking tool comprising one or more processors having memories, in communication with each other (if a plurality) and configured to:
a) receive and store contribution information belonging to at least one of a plurality of individuals subscribing to at least one Defined Contribution Plan Component (DCP Component) at each of contribution instances, forming a time series of contribution amounts (CONs) sorted according to the order of contribution instances;
b) further receive a market value such as but not limited to a Net Asset Value (NAV) of said DCP Component prevailing at the time of each of said contribution instances, forming a time series of NAV values;
c) calculate the number of units (NS) of said DCP Component transacted using said CON amount at the time of said contribution instances;
d) compute a total number of said NS units of said DCP Component held by said individual at the time of each of said contribution instances, forming a time series of said NS units;
e) compute a Net Holding Value (HV) of said DCP Component accumulated by said individual at the time of each of said contribution instances, forming a time series of HV values;
f) normalize said HV values by computing a Nominal Currency Gain parameter (NCG) for the total money invested to acquire said DCP Component at the time of each of said contribution instances, forming a time series of NCG values;
g) compute an Absolute Gain (AG) parameter from said NCG parameter factoring variation in Consumer Price Index (CPI) into account at the time of each of said contribution instance, forming a time series of AG values;
h) find a ratio (CONRATIO) between said CON amount contributed towards purchasing said DCP Component and the total DCP contribution amount at the time of each of said contribution instances, forming a time series of CONRATIO values;
i) compute and form time series of said CON, NS, HV, NCG, AG and CONRATIO values for every said DCP Component subscribed by said individual;
j) sum up NCG and AG time series from every said DCP Component after weighting each time series element with corresponding CONRATIO to form time series of aggregate performance indices of the entire DCP;
k) display on a communicatively coupled Graphic User Interface (GUI), at least one said time-series of at least one of a said CON, NS, HV, NCG, AG, CONRATIO indices or said aggregate performance indices belonging to one or more DCP Components or the entire DCP in the form of a time chart;
l) share with other DCP participants such DCP Component performance indices on a communicatively coupled network interface and
m) create at least one of a plurality of interconnected data sharing platforms, conducive to honest data sharing where confidentiality of sensitive data is preserved while not hiding personal identities of participants.

2. Said DCP performance tracking tool of claim 1 where all data sharing participants are employees of an employer sponsoring said DCP.

3. Said DCP performance tracking tool of claim 1 where data sharing participants are employees of different employers sponsoring different DCPs.

4. A computer implemented method of sharing DCP investment performance while anonymizing asset positions of members comprising:
a) a first step of forming a time series of contribution amounts CONs made by at least one member of a data sharing community towards a DCP Component at each contribution instance;
b) a second step of forming a time series of a performance indices NCGs calculated from market values, including but not limited to the NAVs of said DCP component at each of said contribution instances;
c) a third step of forming a time series of a performance indices AGs calculated from prevailing values of Consumer Price Index (CPI) at each of said contribution instances;
d) a fourth step of forming a time series of CONRATIO fractions that represent the ratio between said CON amount contributed towards purchasing said DCP Component and the total DCP contribution amount at each of said contribution instances;
e) a fifth step of aggregating performance indices NCGs and AGs for an entire DCP from said performance indices NCGs and AGs derived for each of the DCP Components, and their corresponding said CONRATIOs at each of said contribution instances and
f) a sixth step of sharing with other DCP participants such DCP Component performance indices via network coupled computers using Graphical User Interfaces;
thereby, creating a close-knit data sharing community where mutually known member identities promote honest data sharing.

5. Said method of claim 4 where all data sharing participants are employees of an employer sponsoring DCP.

6. Said method of claim 4 where data sharing participants are employees of different employers sponsoring different DCPs.
